(19) United States
(12) Patent Application Publication
(10) Pub. No.: US 2024/0314189 A1
(43) Pub. Date: Sep. 19, 2024

(54) Bluetooth audio playback apparatus and Bluetooth communication method thereof having audio source scanning mechanism

(71) Applicant: REALTEK SEMICONDUCTOR CORPORATION, Hsinchu (TW)

(72) Inventors: Wei-Feng Mao, Suzhou (CN); Zhu-Wei Lu, Suzhou (CN); Ji-Dong Chen, Suzhou (CN); Zuo-Min Li, Suzhou (CN)

(21) Appl. No.: 18/601,323

(22) Filed: Mar. 11, 2024

(30) Foreign Application Priority Data
Mar. 14, 2023 (CN) 202310241256.0

(51) Int. Cl. H04L 65/756; G06F 3/16; G10L 19/005; H04L 65/80; H04W 28/18

(52) U.S. Cl. CPC H04L 65/756; G06F 3/162; G10L 19/005; H04L 65/80; H04W 28/18

(57) ABSTRACT

The present disclosure discloses an audio communication method having two-way high quality audio transmission mechanism that includes steps outlined below. Communication between an audio communication apparatus and an external audio communication apparatus is performed to establish an audio link. An ability negotiation process is performed to determine the external audio communication apparatus supports ACL link technology. A coding negotiation process is performed to negotiate an audio encoding and decoding parameter. An audio delay negotiation process is performed to provide a first audio data delay parameter to the external audio communication apparatus and retrieve a second audio data delay parameter from the external audio communication apparatus to further determine an actual audio data delay parameter. A two-way audio transmission is performed according to the audio encoding and decoding parameter and the actual audio data delay parameter with the external audio communication apparatus.

### BACKGROUND OF THE INVENTION

### 1. Field of the Invention

The present disclosure relates to a Bluetooth audio playback apparatus and a Bluetooth communication method thereof having audio source scanning mechanism.

### 2. Description of Related Art

Wireless communication technologies perform communication without physical wires and thus become the mainstream communication technologies. Among various kinds of wireless communication technologies, Bluetooth technology is developed for over thirty years and is important in the fields of telecom, computer, network and consumer electronics products.

However, along with the higher demands on the audio transmission quality and efficiency, balancing the quality and the speed of two-way audio communication between electronic apparatuses based on Bluetooth technology becomes an important issue.

### SUMMARY OF THE INVENTION

In consideration of the problem of the prior art, an object of the present disclosure is to provide a Bluetooth audio playback apparatus and a Bluetooth communication method thereof having audio source scanning mechanism.

The present invention discloses an audio communication method having two-way high quality audio transmission mechanism that includes steps outlined below. Communication between an audio communication apparatus and an external audio communication apparatus is performed such that the audio communication apparatus establishes an audio link with the external audio communication apparatus. An ability negotiation process is performed by the audio communication apparatus to determine that the external audio communication apparatus supports asynchronous connection-oriented link (ACL) technology. A coding negotiation process is performed by the audio communication apparatus to negotiate an audio encoding and decoding parameter supported by the audio communication apparatus and the external audio communication apparatus. An audio delay negotiation process is performed by the audio communication apparatus to provide a first audio data delay parameter to the external audio communication apparatus and retrieve a second audio data delay parameter from the external audio communication apparatus to further determine an actual audio data delay parameter. A two-way audio transmission based on the ACL technology is performed with the external audio communication apparatus according to the audio encoding and decoding parameter and the actual audio data delay parameter by the audio communication apparatus.

The present invention also discloses an audio communication apparatus having two-way high quality audio transmission mechanism that includes a communication circuit and a processing circuit. The processing circuit is configured to execute an audio communication method that includes steps outlined below. Communication between an audio communication apparatus and an external audio communication apparatus is performed such that the audio communication apparatus establishes an audio link with the external audio communication apparatus. An ability negotiation process is performed by the audio communication apparatus to determine that the external audio communication apparatus supports ACL technology. A coding negotiation process is performed by the audio communication apparatus to negotiate an audio encoding and decoding parameter supported by the audio communication apparatus and the external audio communication apparatus. An audio delay negotiation process is performed by the audio communication apparatus to provide a first audio data delay parameter to the external audio communication apparatus and retrieve a second audio data delay parameter from the external audio communication apparatus to further determine an actual audio data delay parameter. A two-way audio transmission based on the ACL technology is performed with the external audio communication apparatus according to the audio encoding and decoding parameter and the actual audio data delay parameter by the audio communication apparatus.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of an audio communication apparatus having two-way high quality audio transmission mechanism and an external audio communication apparatus performing audio communication with the audio communication apparatus according to an embodiment of the present invention.

FIG. 2 illustrates a flow chart of an audio communication method having two-way high quality audio transmission mechanism according to an embodiment of the present invention.

### DETAILED DESCRIPTION OF THE PREFERRED EMBODIMENTS

An aspect of the present invention is to provide a Bluetooth audio playback apparatus and a Bluetooth communication method thereof having audio source scanning mechanism to allow two-way audio transmission to be performed with high quality.

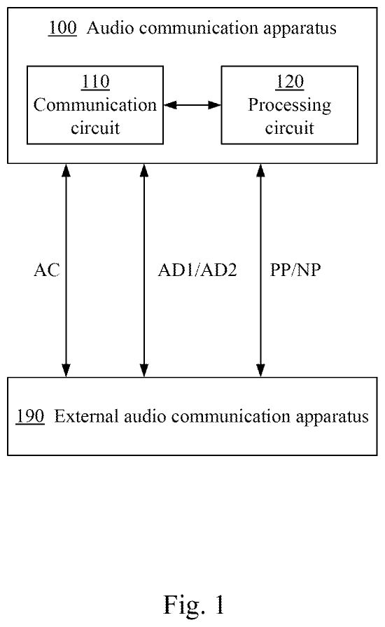

Reference is now made to FIG. 1. FIG. 1 illustrates a block diagram of an audio communication apparatus 100 having two-way high quality audio transmission mechanism and an external audio communication apparatus 190 performing audio communication with the audio communication apparatus 100 according to an embodiment of the present invention.

The audio communication apparatus 100 and the external audio communication apparatus 190 are configured to establish communication link to perform two-way audio transmission.

The audio communication apparatus 100 includes a communication circuit 110 and a processing circuit 120.

The communication circuit 110 can be any circuit that is able to perform network communication. The processing circuit 120 is electrically coupled to the communication circuit 110 to perform network communication through the communication circuit 110. In an embodiment, the processing circuit 120 is used to execute an application program (not illustrated in the figure), in which the application program can be software or firmware stored in such as, but not limited to a storage circuit (not illustrated in the figure) further included in the audio communication apparatus 100. The processing circuit 120 controls the communication circuit 110 under the operation of the application program to execute the function of the audio communication apparatus 100.

The operation of the audio communication apparatus 100 is described in detail in the following paragraphs.

The processing circuit 120 performs communication with the external audio communication apparatus 190 through the communication circuit 110 to establish an audio link with the external audio communication apparatus 190. In an embodiment, a first one of the audio communication apparatus 100 and the external audio communication apparatus 190 serves as an initiating terminal to establish the audio link. A second one of the audio communication apparatus 100 and the external audio communication apparatus 190 serves as a receiving terminal to establish the audio link.

The processing circuit 120 performs an ability negotiation process to determine that the external audio communication apparatus 190 supports asynchronous connection-oriented link (ACL) technology. The ACL technology is a Bluetooth technology based on BREDR ACL that is used to transmit audio signal, in which such a technology is used to transmit the audio signal having a sampling rate up to 44K, 48K or an even higher sampling rate. The ACL technology may perform communication by using the packet types of such as, but not limited to DM1, DH1, DM3, DH3, DM5, DH5, 2-DH1, 2-DH3, 2-DH5, 3-DH1, 3-DH3 and 3-DH5. A transmission speed from 108.8 kilobyte per second (KB/s) to 2178.1 KB/s can be accomplished.

The ability negotiation process can be performed by using such as, but not limited to a handshake procedure. In an embodiment, the ability negotiation process between the audio communication apparatus 100 and the external audio communication apparatus 190 is performed by actively inquiring the receiving terminal for related information by the initiating terminal. In another embodiment, the ability negotiation process between the audio communication apparatus 100 and the external audio communication apparatus 190 is performed by actively reporting the related information to the initiating terminal by the receiving terminal. In yet another embodiment, the ability negotiation process between the audio communication apparatus 100 and the external audio communication apparatus 190 is performed by using predetermined information by both of the initiating terminal and the receiving terminal.

After determining that the external audio communication apparatus 190 supports the ACL technology, the processing circuit 120 performs a coding negotiation process with the external audio communication apparatus 190 to negotiate an audio encoding and decoding parameter AC supported by the both of the audio communication apparatus 100 and the external audio communication apparatus 190. The audio encoding and decoding parameter AC includes an encoding and decoding parameter related to an encoding and decoding algorithm. In an embodiment, the encoding and decoding algorithm includes one of SBC, LC3 and AAC encoding technologies.

The coding negotiation process can be performed by using such as, but not limited to a handshake procedure. In an embodiment, the coding negotiation process between the audio communication apparatus 100 and the external audio communication apparatus 190 is performed by actively inquiring the receiving terminal for related information by the initiating terminal. In another embodiment, the coding negotiation process between the audio communication apparatus 100 and the external audio communication apparatus 190 is performed by actively reporting the related information to the initiating terminal by the receiving terminal. In yet another embodiment, the coding negotiation process between the audio communication apparatus 100 and the external audio communication apparatus 190 is performed by using predetermined information by both of the initiating terminal and the receiving terminal.

After performing the coding negotiation process, the processing circuit 120 performs an audio delay negotiation process to provide a first audio data delay parameter AD1 to the external audio communication apparatus 190 and retrieve a second audio data delay parameter AD2 from the external audio communication apparatus 190, to further determine an actual audio data delay parameter. Each of the first audio data delay parameter AD1 and the second audio data delay parameter AD2 includes a minimum coding data unit size, a packet size, a data transmission interval, flush timeout parameter, a preferential packet type or a combination thereof.

In an embodiment, the actual audio data delay parameter allows the audio communication apparatus 100 and the external audio communication apparatus 190 to perform audio transmission with a minimum latency.

After performing the audio delay negotiation process, the processing circuit 120 performs a two-way audio transmission based on the ACL technology with the external audio communication apparatus 190 according to the audio encoding and decoding parameter AC and actual audio data delay parameter.

In an embodiment, two-way audio transmission is a two-way voice transmission, in which each of the audio communication apparatus 100 and the external audio communication apparatus 190 is an electronic apparatus configured to perform voice communication. However, the present invention is not limited thereto.

In an embodiment, when a first one of the audio communication apparatus 100 and the external audio communication apparatus 190 does not transmit data in the two-way audio transmission, the first one of the audio communication apparatus 100 and the external audio communication apparatus 190 transmits a poll packet PP or a null packet NP to a second one of the audio communication apparatus 100 and the external audio communication apparatus 190.

More specifically, when an upcoming timing is for the first one of the audio communication apparatus 100 and the external audio communication apparatus 190 to perform data transmission and the first one of the audio communication apparatus 100 and the external audio communication apparatus 190 has no data to transmit, the first one of the audio communication apparatus 100 and the external audio communication apparatus 190 can transmit the poll packet PP or the null packet NP to the second one of the audio communication apparatus 100 and the external audio communication apparatus 190 to notify the second one of the audio communication apparatus 100 and the external audio communication apparatus 190 to keep performing audio transmission without the need to wait for the transmission of the first one of the audio communication apparatus 100 and the external audio communication apparatus 190. In an embodiment, a transmission time length of any one of the poll packet PP and the null packet NP is around 0.625 milliseconds. The unnecessary hold time intervals in the transmission between the audio communication apparatus 100 and the external audio communication apparatus 190 can be greatly reduced due to the mechanism described above.

In an embodiment, when the external audio communication apparatus 190 is determined to not support the ACL technology in the ability negotiation process, the processing circuit 120 determines that the external audio communication apparatus 190 supports a synchronous connection-oriented (SCO) link technology or an extended synchronous connection-oriented (extended SCO; eSCO) link technology such that the audio communication apparatus 100 performs two-way audio transmission with the external audio communication apparatus 190 according to the SCO link technology or the eSCO link technology.

In an embodiment, each of the SCO link technology and the eSCO link technology is a Bluetooth technology based on BREDR that is used to transmit audio signal, in which such a technology is used to transmit the audio signal having a sampling rate of 16K. Further, in each of the SCO link technology and the eSCO link technology, when a first one of the audio communication apparatus 100 and the external audio communication apparatus 190 does not transmit data in the two-way audio transmission, the second one of the audio communication apparatus 100 and the external audio communication apparatus 190 has to wait for the termination of the transmission timing of the first one of the audio communication apparatus 100 and the external audio communication apparatus 190 so as to perform audio transmission. More unnecessary hold time intervals are thus presented between the transmission of the audio communication apparatus 100 and the external audio communication apparatus 190.

As a result, after performing the ability negotiation process, the coding negotiation process and the audio delay negotiation process with the external audio communication apparatus, the audio communication apparatus of the present invention performs two-way audio transmission according to the ACL technology that supports higher sampling rates. Not only the audio transmission quality is increased, but also unnecessary hold time intervals can be avoided to increase the efficiency of the audio transmission.

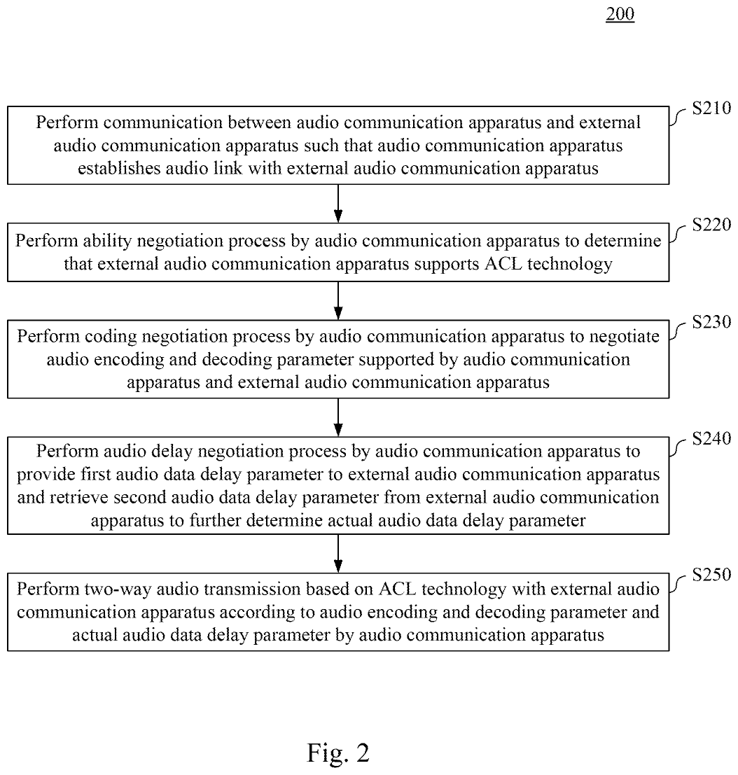

Reference is now made to FIG. 2. FIG. 2 illustrates a flow chart of an audio communication method 200 having two-way high quality audio transmission mechanism according to an embodiment of the present invention.

Besides the apparatus described above, the present invention further discloses the audio communication method 200 having two-way high quality audio transmission mechanism that can be used in such as, but not limited to the audio communication apparatus 100 illustrated in FIG. 1. An embodiment of the audio communication method 200 is illustrated in FIG. 2 and includes the steps outlined below.

In step S210, communication between the audio communication apparatus 100 and the external audio communication apparatus 190 is performed such that the audio communication apparatus 100 establishes the audio link with the external audio communication apparatus 190.

In step S220, the ability negotiation process is performed by the audio communication apparatus 100 to determine that the external audio communication apparatus 190 supports ACL technology.

In step S230, the coding negotiation process is performed by the audio communication apparatus 100 to negotiate the audio encoding and decoding parameter AC supported by the audio communication apparatus 100 and the external audio communication apparatus 190.

In step S240, the audio delay negotiation process is performed by the audio communication apparatus 100 to provide the first audio data delay parameter AD1 to the external audio communication apparatus 190 and retrieve the second audio data delay parameter AD2 from the external audio communication apparatus 190 to further determine the actual audio data delay parameter.

In step S250, the two-way audio transmission based on the ACL technology is performed with the external audio communication apparatus 190 according to the audio encoding and decoding parameter AC and the actual audio data delay parameter by the audio communication apparatus 100.

It is appreciated that the embodiments described above are merely an example. In other embodiments, it is appreciated that many modifications and changes may be made by those of ordinary skill in the art without departing, from the spirit of the invention.

In summary, the Bluetooth audio playback apparatus and the Bluetooth communication method thereof having audio source scanning mechanism of the present invention can perform the ability negotiation process, the coding negotiation process and the audio delay negotiation process with the external audio communication apparatus and subsequently perform two-way audio transmission according to the ACL technology that supports higher sampling rates. Not only the audio transmission quality is increased, but also unnecessary hold time intervals can be avoided to increase the efficiency of the audio transmission.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. An audio communication method having two-way high quality audio transmission mechanism, comprising:
performing communication between an audio communication apparatus and an external audio communication apparatus such that the audio communication apparatus establishes an audio link with the external audio communication apparatus;
performing an ability negotiation process by the audio communication apparatus to determine that the external audio communication apparatus supports asynchronous connection-oriented link (ACL) technology;
performing a coding negotiation process by the audio communication apparatus to negotiate an audio encoding and decoding parameter supported by the audio communication apparatus and the external audio communication apparatus;
performing an audio delay negotiation process by the audio communication apparatus to provide a first audio data delay parameter to the external audio communication apparatus and retrieve a second audio data delay parameter from the external audio communication apparatus to further determine an actual audio data delay parameter; and
performing a two-way audio transmission based on the ACL technology with the external audio communication apparatus according to the audio encoding and decoding parameter and the actual audio data delay parameter by the audio communication apparatus.

2. The audio communication method of claim 1, wherein a first one of the audio communication apparatus and the external audio communication apparatus serves as an initiating terminal of the establishment of the audio link, and a second one of the audio communication apparatus and the external audio communication apparatus serves a receiving terminal of the establishment of the audio link, wherein the ability negotiation process, the coding negotiation process and the audio delay negotiation process are performed by actively inquiring the receiving terminal for related information by the initiating terminal, by actively reporting the related information to the initiating terminal by the receiving terminal or by using predetermined information by both of the initiating terminal and the receiving terminal.

3. The audio communication method of claim 1, wherein the audio encoding and decoding parameter comprises an encoding and decoding parameter related to an encoding and decoding algorithm, and the encoding and decoding algorithm includes one of SBC, LC3 and AAC encoding technologies.

4. The audio communication method of claim 1, wherein each of the first audio data delay parameter and the second audio data delay parameter includes a minimum coding data unit size, a packet size, a data transmission interval, a flush timeout parameter, a preferential packet type or a combination thereof.

5. The audio communication method of claim 1, further comprising:
when a first one of the audio communication apparatus and the external audio communication apparatus does not transmit data in the two-way audio transmission, the first one of the audio communication apparatus and the external audio communication apparatus transmits a poll packet or a null packet to a second one of the audio communication apparatus and the external audio communication apparatus.

6. The audio communication method of claim 1, further comprising:
when the external audio communication apparatus is determined to not support the ACL technology in the ability negotiation process, the external audio communication apparatus is determined to support a synchronous connection-oriented (SCO) link technology or an extended synchronous connection-oriented (eSCO) link technology.

7. The audio communication method of claim 1, wherein the two-way audio transmission is a two way voice transmission.

8. An audio communication apparatus having two-way high quality audio transmission mechanism, comprising:
a communication circuit; and
a processing circuit configured to execute an audio communication method, comprising:
performing communication with an external audio communication apparatus through the communication circuit to establish an audio link with the external audio communication apparatus;
performing an ability negotiation process to determine that the external audio communication apparatus supports ACL technology;
performing a coding negotiation process with the external audio communication apparatus to negotiate an audio encoding and decoding parameter supported by the audio communication apparatus and the external audio communication apparatus;
performing an audio delay negotiation process by the audio communication apparatus to provide a first audio data delay parameter to the external audio communication apparatus and retrieve a second audio data delay parameter from the external audio communication apparatus to further determine an actual audio data delay parameter; and
performing a two-way audio transmission based on the ACL technology with the external audio communication apparatus according to the audio encoding and decoding parameter and the actual audio data delay parameter by the audio communication apparatus.

9. The audio communication apparatus of claim 8, wherein a first one of the audio communication apparatus and the external audio communication apparatus serves as an initiating terminal of the establishment of the audio link, and a second one of the audio communication apparatus and the external audio communication apparatus serves a receiving terminal of the establishment of the audio link, wherein the ability negotiation process, the coding negotiation process and the audio delay negotiation process are performed by actively inquiring the receiving terminal for related information by the initiating terminal, by actively reporting the related information to the initiating terminal by the receiving terminal or by using predetermined information by both of the initiating terminal and the receiving terminal.

10. The audio communication apparatus of claim 8, wherein the audio encoding and decoding parameter comprises an encoding and decoding parameter related to an encoding and decoding algorithm, and the encoding and decoding algorithm includes one of SBC, LC3 and AAC encoding technologies.

11. The audio communication apparatus of claim 8, wherein each of the first audio data delay parameter and the second audio data delay parameter includes a minimum coding data unit size, a packet size, a data transmission interval, a flush timeout parameter, a preferential packet type or a combination thereof.

12. The audio communication apparatus of claim 8, wherein the audio communication method further comprising:
when a first one of the audio communication apparatus and the external audio communication apparatus does not transmit data in the two-way audio transmission, the first one of the audio communication apparatus and the external audio communication apparatus transmits a poll packet or a null packet to a second one of the audio communication apparatus and the external audio communication apparatus.

13. The audio communication apparatus of claim 8, wherein the audio communication method further comprising:
when the external audio communication apparatus is determined to not support the ACL technology in the ability negotiation process, the external audio communication apparatus is determined to support a synchronous connection-oriented (SCO) link technology or an extended synchronous connection-oriented (eSCO) link technology

14. The audio communication apparatus of claim 8, wherein the two-way audio transmission is a two way voice transmission.
